(19) United States
(12) Patent Application Publication
(10) Pub. No.: US 2019/0171949 A1
(43) Pub. Date: Jun. 6, 2019

(54) MODEL TRAINING SYSTEM, OPERATING METHOD OF MODEL TRAINING SYSTEM AND PORTABLE ELECTRONIC DEVICE

(71) Applicant: INSTITUTE FOR INFORMATION INDUSTRY, Taipei City (TW)

(72) Inventors: Chen-Kuo CHIANG, Minxiong Township (TW); Cheng-Yeh CHEN, Hsinchu City (TW); Yi-Ting CHIANG, Taipei City (TW)

(73) Assignee: INSTITUTE FOR INFORMATION INDUSTRY, Taipei City (TW)

(21) Appl. No.: 15/833,197

(22) Filed: Dec. 6, 2017

(30) Foreign Application Priority Data
Dec. 4, 2017 (CN) 201711259683.2

(51) Int. Cl. G06N 5/04; G06N 99/00

(52) U.S. Cl. CPC G06N 5/04; G06N 3/04; G06N 99/005

(57) ABSTRACT

A model training system, an operating method of the model training system and a portable electronic device are provided. The operating method is implemented by a processor. The model training system includes a first model and at least one second model. The processor receives an inputting data. The processor obtains a model difference between the first model and the second model according to the inputting data. The processor obtains an outputting accuracy of the second model according to the inputting data. The processor updates at least one parameter of the second model according to the outputting accuracy and the model difference.

This application claims the benefit of People's Republic of China application Serial No. 201711259683.2, filed Dec. 4, 2017, the disclosure of which is incorporated by reference herein in its entirety.

### TECHNICAL FIELD

The disclosure relates in general to a model training system, an operating method of the model training system and a portable electronic device, and more particularly to a model training system adopted a deep learning algorithm for a portable electronic device, the operating method of the model train system and the portable electronic device.

### BACKGROUND

Deep learning technology has high accuracy, so researchers try to apply the deep learning technology to image recognition, motion recognition, and physiological perception.

However, a deep learning model has many layers and the complexity is quite high, so it cannot be applied to the portable electronic device. Therefore, the deep learning technology cannot be successfully applied to image recognition, motion recognition, and physiological perception.

Besides, the deep learning model is also encountered with the problem of over-fitting, and cannot be applied to the personalized application.

### SUMMARY

The disclosure is directed to a model training system, an operating method of the model training system and a portable electronic device. Two models are used in the model training system, such that the deep learning technology can be applied to the portable electronic device for learning personal data.

According to one embodiment, an operating method of a model training system is provided. The operating method is implemented by a processor. The model training system includes a first model and at least one second model. The operating method includes the following steps. The processor receives an inputting data. The processor obtains a first intermediate layer data of the first model and a second intermediate layer data of the second model according to inputting data. A difference between the first intermediate layer data and the second intermediate layer data is a model difference between the first model and the second model. The processor inputs the inputting data to the second model to obtain an output value, and compares the output value and a target value to obtain an outputting accuracy of the second model. The processor updates at least one parameter of the second model according to the outputting accuracy and the model difference.

According to another embodiment, a model training system includes a first model, at least one second model, an inputting unit and a processor. The inputting unit is used for providing an inputting data. The processor is used for executing an instruction set. The instruction set includes a difference analyzing unit, an accuracy analyzing unit and a model modifying unit. The difference analyzing unit is used for obtaining a first intermediate layer data of the first model and a second intermediate layer data of the second model according to the inputting data. A difference between the first intermediate layer data and the second intermediate layer data is a model difference between the first model and the second model. An accuracy analyzing unit is used for inputting the inputting data to the second model to obtain an output value, and comparing the outputting value and a target value to obtain an outputting accuracy of the second model. The model modifying unit is used for updating at least one parameter of the second model according to the outputting accuracy and the model difference.

According to an alternative embodiment, a portable electronic device is provided. The portable electronic device is communicated with a server. The server includes a first model. The portable electronic device includes an inputting unit, a second model and a processor The inputting unit is used for receiving an inputting data. The processor is used for executing an instruction set. The instruction set includes a difference analyzing unit, an accuracy analyzing unit and a model modifying unit. The difference analyzing unit is used for obtaining a first intermediate layer data of the first model and a second intermediate layer data of the second model according to the inputting data. A difference between the first intermediate layer data and the second intermediate layer data is a model difference between the first model and the second model. The accuracy analyzing unit is used for inputting the inputting data to the second model to obtain an output value, and comparing the outputting value and a target value to obtain an outputting accuracy of the second model. The model modifying unit is used for updating at least one parameter of the second model according to the outputting accuracy and the model difference.

### BRIEF DESCRIPTION OF THE DRAWINGS

FIG. 1 shows a model training system according to one embodiment.

FIG. 2 shows a block diagram of the model training system according to one embodiment.

FIG. 3 shows a flowchart of an operation method of the model training system according to one embodiment.

FIG. 4 illustrates the step S140 of FIG. 3.

FIG. 5 shows a model training system according to another embodiment.

FIG. 6 shows a flowchart of an operating method of the model training system according to another embodiment.

FIG. 7 shows a model training system according to another embodiment.

FIG. 8 shows an operation method of the model training system according to another embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

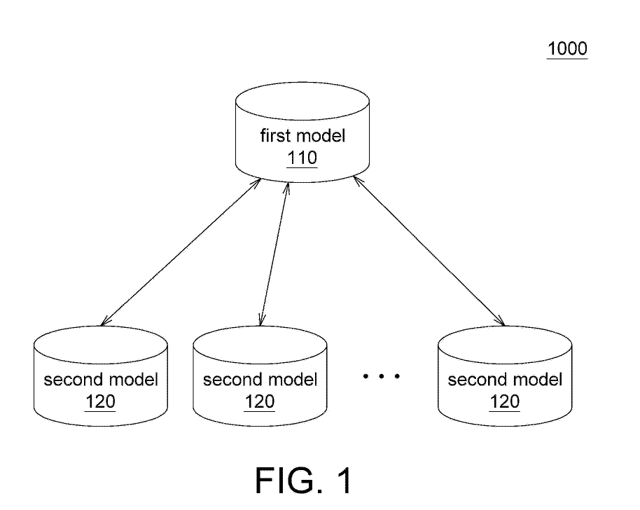

Please refer to FIG. 1, which shows a model training system 1000 according to one embodiment. The model training system 1000 includes a first model 110 and one or more second models 120. The first model 110 is an auxiliary top layer model with big data, and the second model 120 is a target bottom layer model with personal data. For example, the first model 110 and the second model 120 may be deep learning models. The deep learning model is an Artificial Neural Networks (ANNs) model, etc. The first model 110 is complex and has many layers for dealing with big data and can be executed at a cloud computing center. The second model 120 has fewer layers and can be executed at the portable electronic device. The huge resources of the first model 110 can be used to assist the learning of the second model 120, and the data of the second model 120 can be feedback to the first model 110 for improving the model accuracy. Through the two-way channel architecture formed by the first model 110 and the second model 120, the deep learning technology can be applied to the portable electronic device.

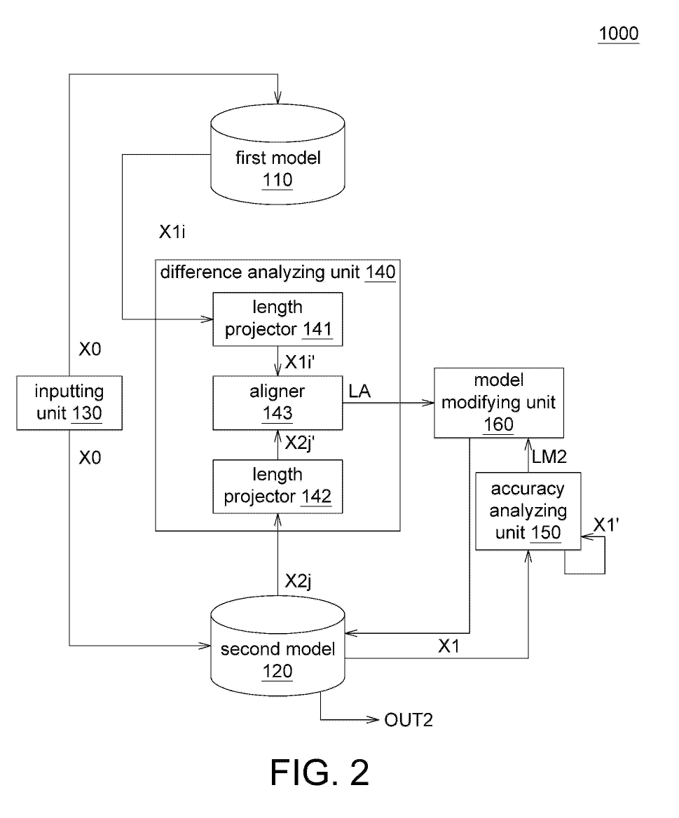

Please refer to FIG. 2, which shows a block diagram of the model training system 1000 according to one embodiment. The model training system 1000 includes a first model 110, one or more second models 120 (only one second model 120 is shown in FIG. 2), and an inputting unit 130. The model training system 1000 can be implemented by a processor for executing an instruction set. The instruction set includes difference analyzing unit 140, an accuracy analyzing unit 150 and a model modifying unit 160. The inputting unit 130 is used for inputting information. For example, the inputting unit 130 may be a heart rate sensor, an image recognition device, a keyboard, a gyroscope, or a network transmission device. The difference analyzing unit 140 is used for analyzing the difference between two models. The accuracy analyzing unit 150 is used for analyzing the accuracy of the output of one model. The model modifying unit 160 is used for updating and modifying one model.

The model training system 1000 may be composed of a server and a portable electronic device. In one embodiment, the server includes the first model 110; the portable electronic device includes the second model 120, the inputting unit 130 and a processor executing the instruction set. Or, in another embodiment, the server includes the first model 110 and a processor executing a portion of the instruction set; the portable electronic device includes the second model 120, the inputting unit 130 and a processor executing another portion of the instruction set. The invention is not limited to the configuration of the server and the portable electronic device, and the designer can modify the configuration to meet the need of use.

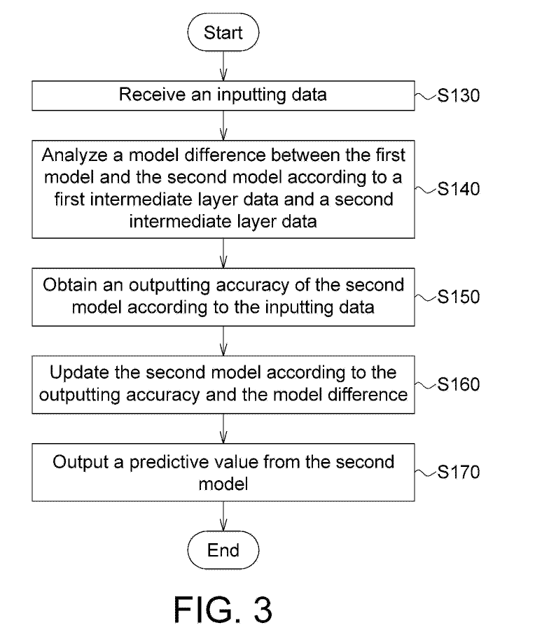

A flowchart is used to illustrate the operation of the model training system 1000. Please refer to FIG. 3, which shows a flowchart of an operation method of the model training system 1000 according to one embodiment. The model training system 1000 includes the first model 110 and the second model 120. The first model 110 is an auxiliary top layer model with big data, and the second model 120 is a target bottom layer model with personal data.

In step S130, the inputting unit 130 receives an inputting data X0. The inputting unit 130 may obtain the inputting data X0 by detecting the physiological status or identifying the exercise posture. The inputting data X0 may be transmitted to the first model 110 and the second model 120.

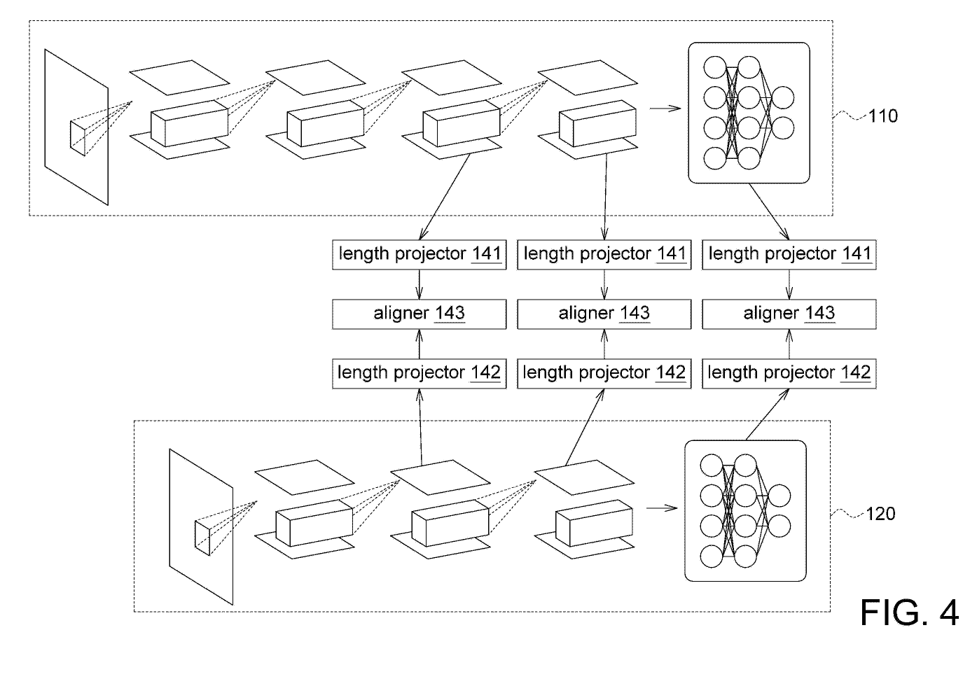

Next, in step S140, the difference analyzing unit 140 analyzes a model difference LA between the first model 110 and the second model 120 according to the inputting data X0. Please refer to FIG. 4, which illustrates the step S140 of FIG. 3. The first model 110 and the second model 120 are deep learning models. The data in several layers may be different in length, so an Auxiliary Structure Learning (ASL) algorithm is needed for assisting the analyzing of the model difference LA. As shown in FIGS. 2 and 4, the difference analyzing unit 140 includes two length projectors 141, 142 and an aligner 143. The length projectors 141, 142 are used for adjusting the length of data, and the aligner 143 is used for comparing the data.

As shown in FIG. 3, in step S140, the first model 110 generates a first intermediate layer data X1i which is the output of the i-th layer in the first model 110 according to the inputting data X0.

The second model 120 generates a second intermediate layer data X2j which is the output of the j-th layer of the second model 120 according to the inputting data X0.

The length projector 141 adjusts the first intermediate layer data X1i or the length projector 142 adjusts the second intermediate layer data X2j, such that the length of an adjusted first intermediate layer data X1i′ and the length of an adjusted second intermediate layer data X2j′ are identical. The aligner 143 compares the adjusted first intermediate layer data X1i′ and the adjusted second intermediate layer data X2j′ to obtain the model difference LA between the first model 110 and the second model 120. For example, the model difference LA may be calculated according to the equation (1).

$$LA = {\sum }_{∀ i , j} {λ}_{i , j} \times ‖ X 1 {i}^{′} - X 2 {j}^{′} ‖ \qquad ( 1 )$$

λ_{i,j} is the weight which is used for representing the influence in each layer.

In one embodiment, if the length of the first intermediate layer data X1i and the length of the second intermediate layer data X2j is identical, it is no need to adjust them by the length projectors 141, 142. Or, in another embodiment, only one of the length projectors 141, 142 is needed to adjust only one of the first intermediate layer data X1i and the second intermediate layer data X2j.

Afterwards, in step S150, the accuracy analyzing unit 150 obtains an outputting accuracy LM2 of the second model 120 according to the inputting data X0. For example, the accuracy analyzing unit 150 inputs the inputting data X0 to the second model 120 to obtain an output value X1, and compares the output value X1 and a target value X1′ to obtain the outputting accuracy LM2 of the second model 120.

Then, in step S160, the model modifying unit 160 updates the second model 120 according to the outputting accuracy LM2 and the model difference LA via a deep learning algorithm. For example, the deep learning algorithm may be a Stochastic Gradient Descent (SGD) algorithm or an Adaptive Moment Estimation (ADAM) algorithm.

By performing the steps above, the model difference LA between the first model 110 and the second model 120 is used to assist the learning of the second model 120, so the learning of the second model 120 can be sped up and the accuracy can be improved through big data. The second model 120 is different from the first model 110 in that the second model 120 is created via personal data, so the second model 120 is still suitable for the personalized application.

After the second model 120 is updated by learning, in step S170, a predictive value OUT2 outputted from the second model 120 is an accurate and personalized prediction.

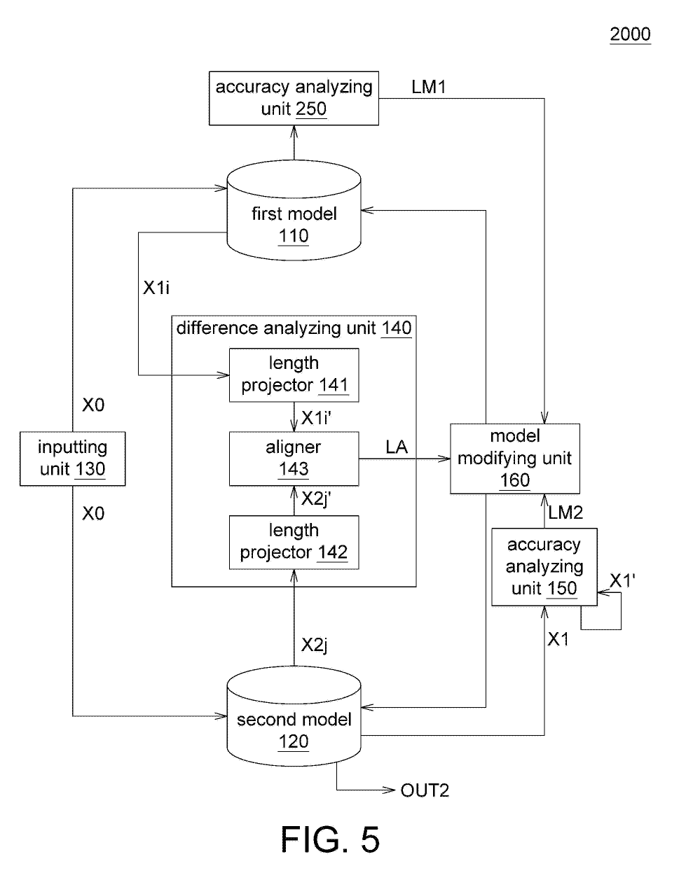

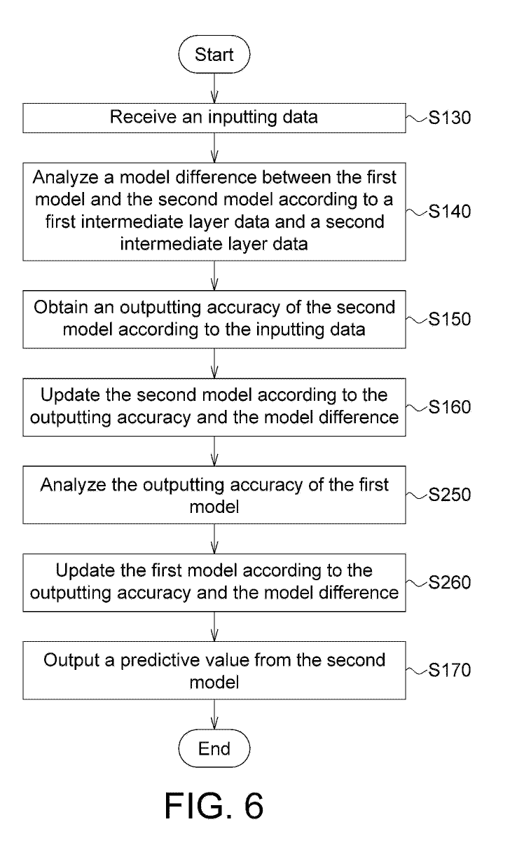

Besides, the elements and steps described above can be changed for different needs. Please refer to FIGS. 5 and 6. FIG. 5 shows a model training system 2000 according to another embodiment, and FIG. 6 shows a flowchart of an operating method of the model training system 2000 according to another embodiment. The model training system 2000 further includes an accuracy analyzing unit 250. The accuracy analyzing unit 250 is used for analyzing an outputting accuracy LM1 of the first model 110.

In this embodiment, the operation method of the model training system 2000 further includes steps S250 and S260. In step S250, the accuracy analyzing unit 250 analyzes the outputting accuracy LM1 of the first model 110 according to the inputting data X0. In step S260, the model modifying unit 160 updates the first model 110 according to the outputting accuracy LM1 and the model difference LA. That is to say, the second model 120 may assist the learning of the first model 110, such that the accuracy of the first model 110 can be improved. In one embodiment, the number of the second model 120 may be more than one, so the first model 110 can be updated according to those second models 120.

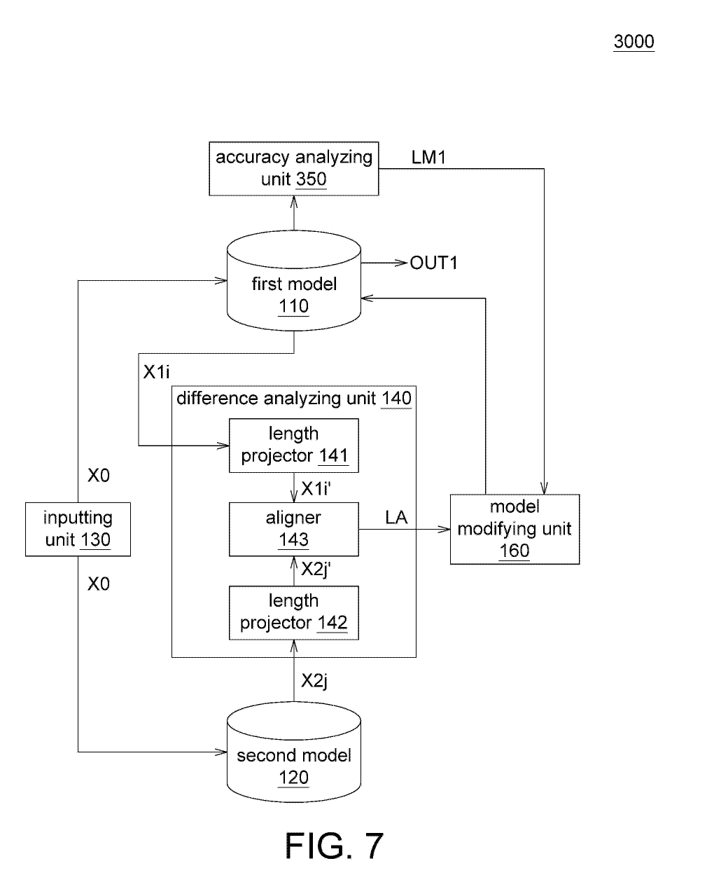

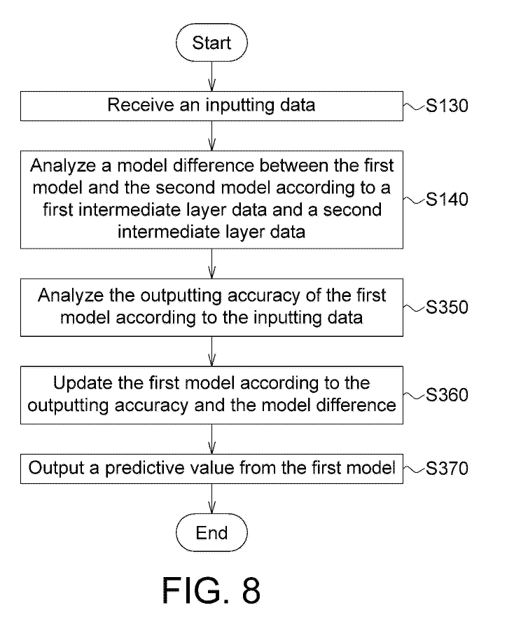

Moreover, please refer to FIGS. 7 and 8. FIG. 7 shows a model training system 3000 according to another embodiment. FIG. 8 shows an operation method of the model training system 3000 according to another embodiment. In this embodiment, the learning and the prediction of the second model 120 are not performed. The second model 120 is just used for assisting the first model 110. The portable electronic device having the second model 120 needs less computing resource, so the volume and weight of the portable electronic device can be reduced.

In step S350, the accuracy analyzing unit 350 analyzes the outputting accuracy LM1 of the first model 110 according to the inputting data X0.

In step S360, the model modifying unit 160 updates the first model 110 according to the outputting accuracy LM1 and the model difference LA. In one embodiment, the number of the second model 120 can be more than one, so the first model 110 can be updated according to those second models 120.

That is to say, the second model 120 of this embodiment is only used for assisting the learning of the first model 110, such that the accuracy of the first model 110 can be improved.

After the learning of the first model 110 is performed, in step S370, the first model 110 can accurately output a predictive value OUT1.

According to the embodiments described above, the model training systems 1000, 2000, 3000 adopt the deep learning technology to the portable electronic device for personalized application through the first model 110 and the second model 120. Moreover, the second model 120 can assist the learning of the first model 110 to improve the accuracy.

The model training system and the operating method thereof described in the invention do not preempt whole of the model training. Actually, there are other ways to implement the model training. The present invention is specific to the deep learning technology adopted in the portable electronic device, and specific to the architecture of two models. Further, the technical problem in the present invention is to let a big model be adopted in a portable electronic device without huge computing resource. In the present invention, updating the model according to the model difference is an unconventional way to solve this technical problem, so the invention is not directed to any abstract idea.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An operating method of a model training system, wherein the operating method is implemented by a processor, the model training system includes a first model and at least one second model, and the operating method comprises:
receiving, by the processor, an inputting data;
obtaining, by the processor, a first intermediate layer data of the first model and a second intermediate layer data of the second model according to inputting data, wherein a difference between the first intermediate layer data and the second intermediate layer data is a model difference between the first model and the second model;
inputting, by the processor, the inputting data to the second model to obtain an output value, and comparing the output value and a target value to obtain an outputting accuracy of the second model; and
updating, by the processor, at least one parameter of the second model according to the outputting accuracy and the model difference.

2. The operating method of the model training system according to claim 1, wherein the processor updates the at least one parameter of the second model via a deep learning algorithm.

3. The operating method of the model training system according to claim 2, wherein the deep learning algorithm includes a Stochastic Gradient Descent (SGD) algorithm and an Adaptive Moment Estimation (ADAM) algorithm.

4. The operating method of the model training system according to claim 1, further comprising:
updating at least one parameter of the first model according to the model difference via a deep learning algorithm.

5. The operating method of the model training system according to claim 4, wherein the deep learning algorithm includes a Stochastic Gradient Descent (SGD) algorithm and an Adaptive Moment Estimation (ADAM) algorithm.

6. The operating method of the model training system according to claim 1, wherein the first intermediate layer data and the second intermediate layer data are adjusted, such that a length of the first intermediate layer data which is adjusted and a length of the second intermediate layer data which is adjusted are identical.

7. The operating method of the model training system according to claim 1, wherein the number of layers of the first model is larger than the number of layers of the second model.

8. The operating method of the model training system according to claim 1, wherein the number of the at least one second model is more than one, and the first model corresponds to the second models.

9. A model training system, comprising:
a first model;
at least one second model;
an inputting unit used for providing an inputting data; and
a processor used for executing an instruction set, wherein the instruction set includes:
a difference analyzing unit used for obtaining a first intermediate layer data of the first model and a second intermediate layer data of the second model according to the inputting data, wherein a difference between the first intermediate layer data and the second intermediate layer data is a model difference between the first model and the second model;
an accuracy analyzing unit used for inputting the inputting data to the second model to obtain an output value, and comparing the outputting value and a target value to obtain an outputting accuracy of the second model; and
a model modifying unit used for updating at least one parameter of the second model according to the outputting accuracy and the model difference.

10. The model training system according to claim 9, wherein the model modifying unit updates the at least one parameter of the second model via a deep learning algorithm.

11. The model training system according to claim 10, wherein the deep learning algorithm includes a Stochastic Gradient Descent (SGD) algorithm and an Adaptive Moment Estimation (ADAM) algorithm.

12. The model training system according to claim 9, wherein the model modifying unit further updates at least one parameter of the first model according to the model difference via a deep learning algorithm.

13. The model training system according to claim 12, wherein the deep learning algorithm includes a Stochastic Gradient Descent (SGD) algorithm and an Adaptive Moment Estimation (ADAM) algorithm.

14. The model training system according to claim 9, wherein the difference analyzing unit further comprises:
a length projector used for adjusting the first intermediate layer data and the second intermediate layer data, such that a length of the first intermediate layer data which is adjusted and a length of the second intermediate layer data which is adjusted are identical.

15. The model training system according to claim 9, wherein the number of layers of the first model is larger than the number of layers of the second model.

16. The model training system according to claim 9, wherein the number of the at least one second model is more than one, and the first model corresponds to the second model.

17. The model training system according to claim 16, wherein the second models and the first model are different.

18. A portable electronic device, communicated with a server, wherein the server includes a first model, and the portable electronic device comprises:
an inputting unit used for receiving an inputting data;
a second model; and
a processor used for executing an instruction set, wherein the instruction set includes:
a difference analyzing unit used for obtaining a first intermediate layer data of the first model and a second intermediate layer data of the second model according to the inputting data, wherein a difference between the first intermediate layer data and the second intermediate layer data is a model difference between the first model and the second model;
an accuracy analyzing unit used for inputting the inputting data to the second model to obtain an output value, and comparing the outputting value and a target value to obtain an outputting accuracy of the second model; and
a model modifying unit used for updating at least one parameter of the second model according to the outputting accuracy and the model difference.

19. The portable electronic device according to claim 18, wherein the model modifying unit updates the at least one parameter of the second model via a deep learning algorithm.

20. The portable electronic device according to claim 19, wherein the deep learning algorithm includes a Stochastic Gradient Descent (SGD) algorithm and an Adaptive Moment Estimation (ADAM) algorithm.

21. The portable electronic device according to claim 18, wherein the difference analyzing unit further comprises:
a length projector used for adjusting the first intermediate layer data and the second intermediate layer data, such that a length of the first intermediate layer data which is adjusted and a length of the second intermediate layer data which is adjusted are identical.

22. The portable electronic device according to claim 18, wherein the number of layers of the first model is larger than the number of layers of the second model.

23. The portable electronic device according to claim 18, wherein the model modifying unit further updates at least one parameter of the first model according to the model difference via a deep learning algorithm.

24. The portable electronic device according to claim 23, wherein the deep learning algorithm includes a Stochastic Gradient Descent (SGD) algorithm and an Adaptive Moment Estimation (ADAM) algorithm.
